(19) United States
(12) Patent Application Publication
(10) Pub. No.: US 2008/0198998 A1
(43) Pub. Date: Aug. 21, 2008

(54) Strategic Telecom Optimized Routing Machine

(75) Inventor: Sergey Aleynikov, Newark, NJ (US)

Correspondence Address: OBLON, SPIVAK, MCCLELLAND MAIER & NEUSTADT, P.C., 1940 DUKE STREET, ALEXANDRIA, VA, 22314, US

(73) Assignee: IDT Corporation, Newark, NJ (US)

(21) Appl. No.: 11/577,468

(22) PCT Filed: Oct. 19, 2005
(86) PCT No.: PCT/US05/37382

§ 371 Date: Apr. 2, 2008

Related U.S. Application Data
(60) Provisional application No. 60/619,775, filed on Oct. 19, 2004.

(51) Int. Cl. H04M 7/00

(52) U.S. Cl. 379/221.01

(57) ABSTRACT

A method of routing calls through a network (5) includes: receiving an incoming call at a signaling transfer point (STP); transferring information related to the incoming call to a routing engine by decoding ISUP signaling information related to the incoming call; determining an optimized route based at least in part on the transferred information; and signaling the STP to a destination number based on the optimized route.

### BACKGROUND OF THE INVENTION

### Field of the Invention

The routing of calls through telephone networks to achieve least cost or best cost routing can be a complicated process. In the past, call routes through switches and carriers were decided through a combination of Microsoft Excel spreadsheets using a manual process. This process entailed dozens of linked Microsoft Excel spreadsheets. These spreadsheets were difficult to expand, and easily reached maximum capacity.

Additionally, these spreadsheets required the manual input of data across spreadsheets. Once all the commercial information was inputted into the spreadsheets, an additional three to four hours were required before the updates would actually hit the switches and affect routing. This delay in routing updates resulted in ineffective cost routing over the network and poor selection of carriers.

### SUMMARY OF THE INVENTION

The strategic telecom optimized routing machine (STORM) suite of applications of the present invention provides computer-based call routing and management capabilities that are not constrained by limitations imposed by switch-based routing. Through the present invention, it is possible to achieve an improved profitability margin for each call, and quicker responses to carrier outages. STORM routing also more effectively achieves call routing with economic efficiency that satisfies individual customers' business needs.

To overcome the problem of switches being “unaware of each other,” changes to routing options are no longer made offline and loaded onto the switches. Rather, the routing function is removed from the switches and placed on a server. This overcomes limitations in switches, which previously prevented the telecommunications provider from maximizing all possible carrier supplied rates.

Additionally, through the present invention, it is possible to route incoming calls on paths that are tailored to the individual customers' needs. It is also possible to change routing parameters based on the time of day (e.g., multiple peak and off-peak time periods). Through the present invention routing alterations may hit switches at desired intervals (e.g., instantly or after 15 minutes, etc.), which enables improved network performance.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 represents an overview of the STORM network;

FIG. 2 represents an overview of the rules engine architecture;

FIGS. 3A and 3B illustrate a non-limiting example of a method of implementing the present invention;

FIG. 4 illustrates an overview of the architecture of a non-limiting aspect of the present invention;

FIG. 5 provides a non-limiting example of carriers and trunk lines according to the present invention;

FIGS. 6A-6D illustrate non-limiting examples of routing tables according to the present invention;

FIG. 7 illustrates a non-limiting example of a tandem network according to the present invention;

FIG. 8 illustrates a non-limiting example of the call control layer of an aspect of the present invention; and

FIG. 9 illustrates a non-limiting example of an ISUP call configuration according to an aspect of the present invention.

### DETAILED DESCRIPTION OF THE PREFERRED EMBODIMENTS

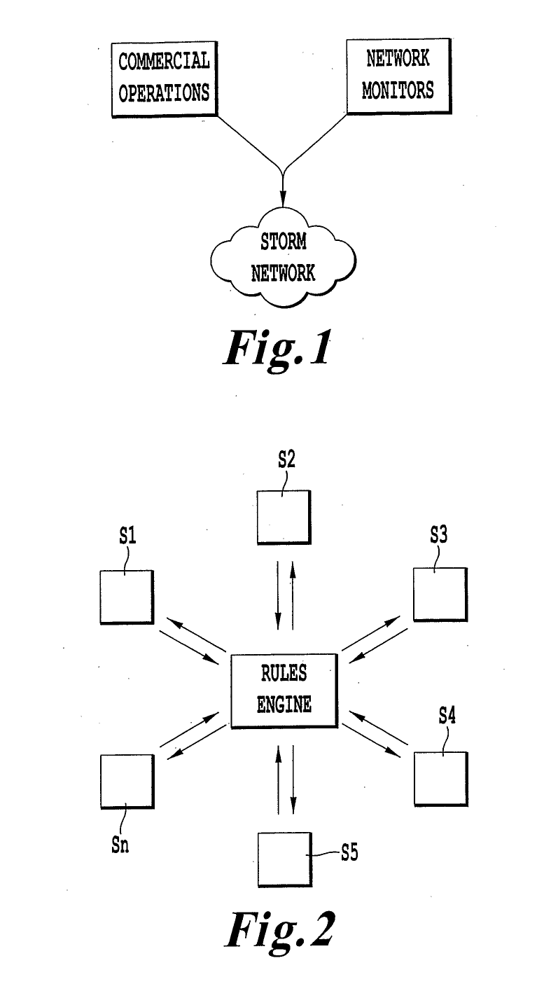

Referring now to the drawings, wherein like reference numerals designate identical or corresponding parts throughout the several views, an overview of the STORM network is illustrated in FIG. 1. For the purposes of the following discussion, a trunk is defined as a communication path connecting two switching systems used to establish an end to end connection. In selected applications, a trunk may have both its terminations in the same switching system. A trunk group is defined as a set of trunks, traffic engineered as a unit, for the establishment of connections within or between switching systems in which all of the paths may be interchangeable where subgrouped.

As shown in FIG. 1, commercial operations 3 and network monitors 1 input information into the STORM network 5. This information may include carrier rate of failure, price per call per route, customers' desired quality criteria, as well as other factors known to those of skill in the art.

As illustrated in FIG. 2, STORM includes a rules engine (e.g., routing server), which is unconstrained by route list size capacity in the switches. The rules engine is also able to express business rules that are beyond the capability of the switches' internal processing. The routes and rules computed by the rules engine are made available real time inside the route server. This server is available to the telephone switches S1-Sn through a control layer. For example, as illustrated in FIG. 4, the route server 30 communicates with the STP layer 10 (e.g., a Sonus switch running version 4.1 software) via control layer 20. The rules engine provides an interface between the real time route server and the virtual switch components.

To improve customer service, network utilization, and profitability, the present invention may track certain information related to an incoming call. The information includes, but is not limited to, call quality requirements, acceptable margins of cost, destination telephone number, number of routes requested, time of day, number of minutes, as well as other factors known to those of skill in the art. The call destination may be identified by a variety of factors. One factor is the dialing code (the smallest granularity which represents dialing digits). Another factor includes the buy location, which is a group of dialing codes defined by an outbound carrier. The buy location is generally meaningful in the context of the outbound carrier to which it is related. The destination may also be identified using the reporting location. A reporting location is a group of dialing codes defined by IDT based on how these destinations are sold to its customers. Of course, a country, which includes a number of reporting locations, may be used to determine the destination. The route server 30 may use this information to generate routing lists.

Generally, an originating call request from a physical switch is resolved to the longest dialing code registered with the system. This dialing code may be used to determine the call destination. Advantageously, each country or dialing code for every switch may have the option to control its own availability in routing. In other words, a trunk servicing a particular area code in downtown London may be available for VOIP calls, but may not be available for commercial customers' calls, due to quality requirements or other factors. Because routes may be globally adjusted by the route server based on both the telecommunications provider's desires and/or needs and on the customers' desires and/or needs, it is possible to more effectively route calls through the switches.

To facilitate routing in compliance with customer requirements and/or requests, the customer may be identified in a manner convenient for the telecommunication provider. For example, if a customer belongs to a wholesale division, that customer may be identified by inbound trunk. Otherwise, debit customers may be identified by account (class id), DNIS (dialed number identification service), or a combination thereof. Account management for each customer may be performed on a Trunk Group Editor (TGE), which enables accounts to be created and maintained. Each inbound account or trunk may be assigned a routable division. This setting may determine the routing path for the traffic for an account or trunk.

Routing rules may also be generated based on a combination of the following entities: division (e.g., wholesale customer, debit calling card, etc.), account, customer identification (e.g., for wholesale customers switch/inbound trunk and for retail customers DNIS or ANI (automatic number identification). Generally speaking, it is preferable for granular routing rules to override more generic routing rules (e.g., a rule for a location within a country overrides a rule for a country; a rule for DNIS overrides a rule for an account).

For inter-switch connectivity (e.g., VOIP and TDM (time-division multiplexed)), it is possible to track multiple call requests in a tandem network that belong to the same call and to use a single call reference to associate the requests. Since trunk costs are fixed, tandem connections do not have a cost. Tandem utilization may be controlled using trunk prioritization, according to a non-limiting aspect of the present invention.

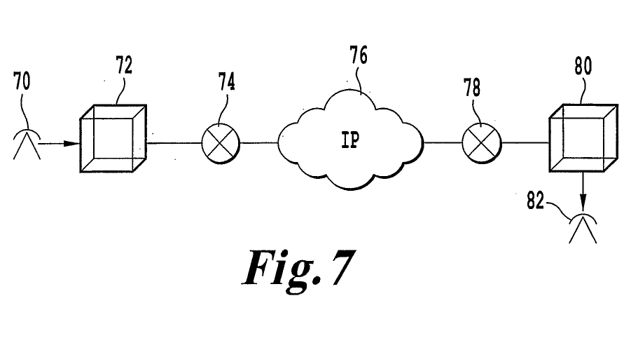

A non-limiting example of a tandem network is illustrated in FIG. 7. As illustrated in FIG. 7, a telephone 70 is used to initiate a call, possibly over an analog network. This call is routed through PBX 72 into voice gateway 74. From voice gateway 74, the call is transferred over an IP network to voice gateway 78. From voice gateway 78, the call is received at PBX 80 and transferred to destination telephone 82. Of course, this illustration of a tandem network is intended as an example only, and other tandem networks are within the scope of the present invention.

Additionally, the present invention may provide a system-wide default cost differential, which (in conjunction with tandem trunk utilization) will affect the precedence of local trunks as opposed to remote trunks on a tandem switch. Generally, shorter tandem paths are preferred. In other words, if more than one path exists to a remote outbound trunk, the shortest path is preferably selected. If there are multiple paths of equal length to a remote trunk, the tandem path is preferentially chosen which has the greatest remaining capacity. As desired, tandem capacity may be reserved for inbound customers, and priority of tandem utilization by inbound customers may be controlled based on division, account, trunk, DNIS, ANI, or other factors known to those of skill in the art.

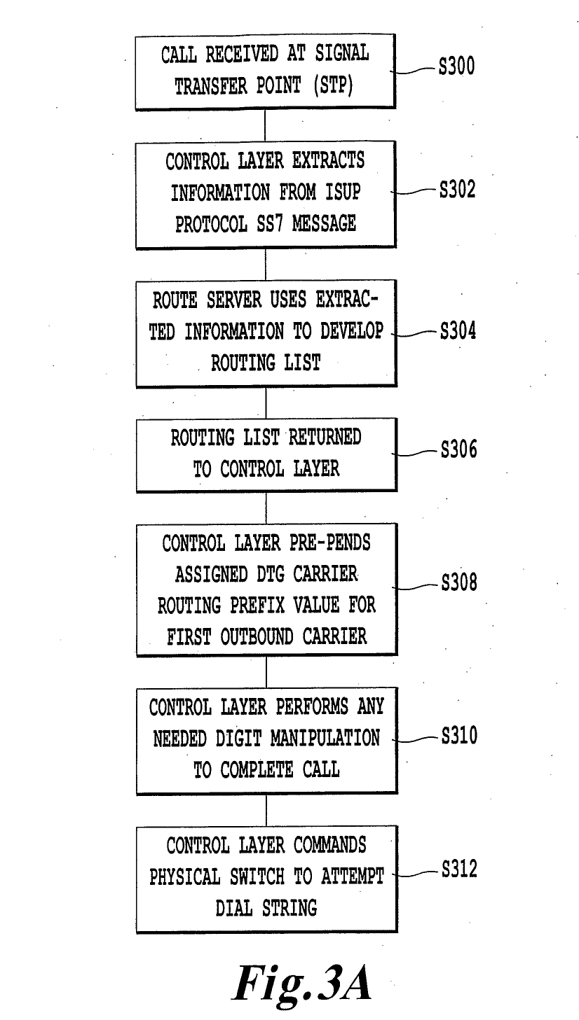

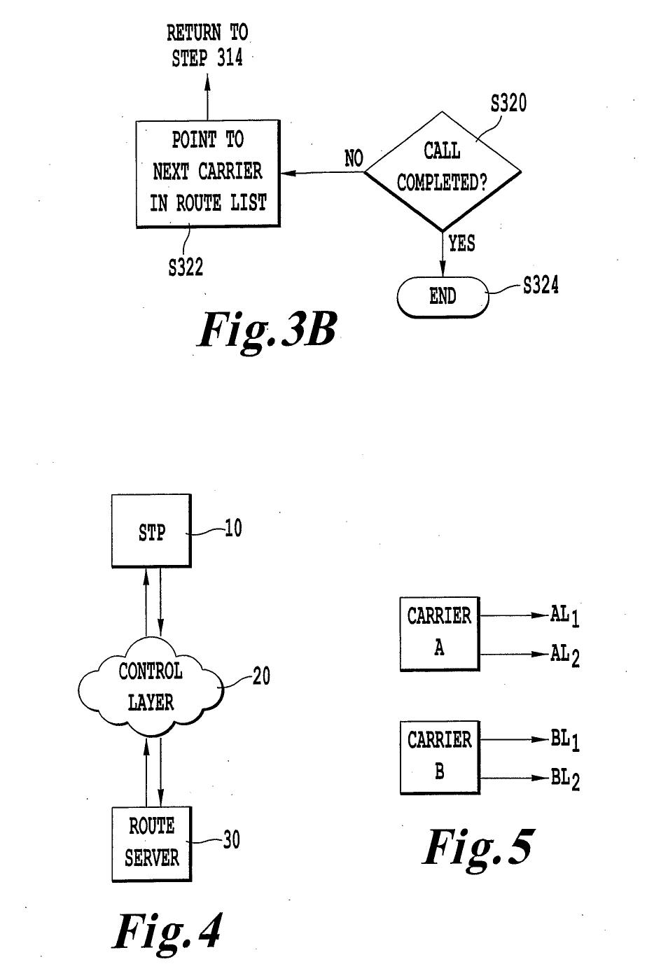

FIGS. 3A and 3B of the present application illustrate the implementation of the call routing system of the present invention. In step S300, a call is received at the STP 10. Once the call is received at the STP 10, the STP 10 informs the control layer 20 of the incoming call in step S302. Upon notification, the control layer 20 decodes ISDN User Part (ISUP) signaling information, determines the best route for the call by consulting the routing database, modifies the ISUP signaling packet to include additional information (destination trunk group—DTG in the form of a destination prefix), unique global call identification reference, and sends the modified ISUP packet back to STP for further routing to the destination switch. By way of further explanation, ISUP defines the protocol and procedures used to set up, manage and release trunk circuits that carry voice and data calls over the PSTN. ISUP may be used for both ISDN and non-ISDN calls. Calls that terminate within the same switch may not use ISUP signaling.

The routing database stores the routing parameters generated by the routing engine. The call control layer consults the routing database, which contains the routing engine route information. The routing database serves as an intermediate layer.

The call control layer 20 stays in the signaling path of the call to determine successful completion of the call by the terminating carrier or rejection of the call (in which case the next available route is iteratively executed as described above until all routes are exhausted).

The packaged information is then passed to the route server 30 in step S306, which uses the information to retrieve a routing list in step S308. The route server 30 then performs hierarchical lookups to account for customer oriented rules (e.g., service level, usage commitments, quality, etc.) in step S310 and returns the prioritized list of outbound carriers (TO₁-TOₘ) and their associated control parameters in step S312. In step S314, the control layer 20 pre-pends the assigned destination trunk group (DTG) carrier routing prefix value for the first outbound carrier in the routing list.

A DTG carrier routing prefix may form the basis of the prioritized list of the outbound carriers to be used. These DTG carrier routing prefixes may uniquely identify the trunk group or gateway (e.g., 028801 may mean ATT on gateway 1 and 028803 may mean ATT on gateway 2, which may have different rates to the same dialing location). Non-limiting examples of gateways are illustrated in FIG. 7 as 72 and 80. The control layer 20 also performs digit manipulation (if needed) to complete the call in step S316. In step S318, the control layer 20 commands the STP 10 to attempt the dial string. If the call is completed in step S320, the process ends at step S324.

If the STP 10 is unable to complete the call, it signals back to the control layer 20 that the call could not be completed. The control layer 20 then points to the next preferred carrier prefix in the route list in step S322 and repeats the process until the call is completed or until the route list is exhausted.

The route server 30 provides information related to the best routes for any given customer. The best route for one customer may or may not be the best route for another customer, depending on a variety of factors. These factors include: required call quality, caller identification ability, price per call, as well as other factors known to those of skill in the art. For example, commercial customers may require a specific level of quality. Accordingly, trunks for commercial customers may be limited to satisfy a quality of service agreement.

Call quality may be measured as a function of the following four criteria: call completion rate (CCR); average length of call (ALOC); post dial delay (PDD); and voice quality. The measurement may account for a weighted average of these factors. It is possible for the telecommunications provider to assign quality requirements for each customer with acceptable variations (e.g., CCR 80% with acceptable variation of +/−10%). If an outbound trunk or carrier falls below a certain quality threshold, the trunk or carrier may be removed from circulation, as desired.

Additionally, for calls to cellular customers in Europe, caller identification may be required. Therefore, trunks having a caller identification capability should be selected for those calls.

The STP 10 includes a number of trunk groups, which can receive calls from customers or send calls to carriers for call completion. As a general rule, switch and trunk configuration may be stored and maintained in a trunk group editor. Additionally, physical switches may be interconnected in a network in which the inter-switch tandem connections are performed using either VOIP or TDM interfaces. In either case, the present invention is able to perform optimal routing with dynamic tandem capacity utilization. Dynamic tandem capacity utilization is achieved when the control layer reports network conditions to the route server, thereby improving network routing. Each physical switch may include attributes to indicate active and inactive periods during which the switch is available for routing to selected destinations. A switch may become unavailable in cases of planned/unplanned maintenance. These attributes enable configuration of the switch without its immediate inclusion in routing.

Outbound carriers may be represented by an account/outbound trunk combination. Any outbound carrier may have multiple trunks on a given account on the same physical switch. Traffic to these trunks is preferably load balanced to prevent carrier failure. Each outbound rate is available for every inbound call across the telecommunication provider's network. Outbound carriers may block traffic to selected dialing codes, buy locations, or reporting locations, as desired to improve network performance. Outbound carriers' quality issues related to poor call completion may be monitored by a subsystem (TrunkMon, disclosed in U.S. patent application Ser. No. 11/024,672, filed Dec. 30, 2004, the entire contents of which are herein incorporated by reference) that feeds quality characteristics back to STORM. STORM, in turn, adjusts routing accordingly.

Generally, a carrier provides rates for groups of dialing codes. A carrier may have a certain number of active rates (e.g., three) with a time indication as to when each rate is active (e.g., the time of day during which the rate is active). Based on the rates provided by the carriers, the present invention may create homogeneous groups of codes. These homogeneous groups represent dialing codes where each carrier has a constant rate.

A carrier may also provide a cap for a certain rate. These caps may be based on several factors. For example, caps may be based on the number of minutes or dollars spent. Caps may apply to country/location or group(s) of countries/locations. Caps may be applied to any subset or combination of weeks/days of week/hours. Caps may start on any day of a month, and may be spread throughout a month or until exhausted.

Rate based caps may also be implemented. In a rate based cap, the rate goes up or down after the cap is exceeded. With ceiling based caps, a carrier should not be given more traffic than the cap permits (e.g., because the carrier's failure rate becomes unacceptable or for other reasons known to those of skill in the art). For floor based caps, a certain minimum number of minutes or dollars must be reached.

Based on these caps, commercial operations of the telecommunications provider may control which carriers are available for routing based on routing rules. These rules enable the system of the present invention to pull a carrier from routing based on desired parameters, such as time interval, periodically, or upon reaching a cap.

To select the carrier, according to a non-limiting aspect of the present invention, a carrier is assigned a routing priority. This priority then impacts the carrier's trunk position in a routing list. The routing rules may be used to adjust the carrier's routing priority. If a carrier's rate becomes capped, the carrier's routing priority may diminish. As a result, the carrier's trunks will drift toward the end of a routing list.

Each outbound account/trunk may include an attribute that controls inclusion of the account/trunk in routing for the whole world or for a location. As desired, the telecommunications provider may limit a list of outbound carriers based on the inbound customer. Additionally, according to a non-limiting aspect of the present invention, it is possible to assign quality requirements for individual customers and to track carriers' quality based on destination.

The faster addition of new routes and rates enables the telecommunications provider to exploit all beneficial rates, which means that a higher percentage of calls is routed at more favorable rates. Additionally, routing decisions are more consistent, while lower management costs are achieved. Best cost routes are not always the same as the least cost routes for any given call, so the present invention is able to determine the best cost route, thereby leading to greater profitability for an entire network for a telecommunications provider.

An example of best cost routing is illustrated in FIG. 5. As shown in FIG. 5, the telecommunications provider may have access to two carriers, A and B. Each of carriers A and B has two outgoing trunk lines, respectively (AL₁, AL₂, BL₁, BL₂). In this example, Carrier A has rates of $0.01 per minute for domestic and $0.05 for international. Carrier B has rates of $0.011 for domestic and $0.09 for international.

Under the rules for least cost routing, if a domestic call comes in, Carrier A is chosen. If a second call is also domestic, Carrier A is again chosen. Thus, trunk lines AL₁ and AL₂ are used for the domestic calls.

If a third call arrives which is international, this third call must be routed through Carrier B, because Carrier A is at capacity. As a result, the telecommunications provider, while saving $0.001 per minute on the domestic calls is losing $0.04 per minute on the international call, because the telecommunications provider is required to pay the higher rate for Carrier B on the international call. The total cost for the above example is $0.11 per minute.

Through the best cost routing of the present invention, the telecommunications provider may apply historical calling information to use its carrier capacity. In the above example, if the expected demand for a given time period is two domestic and one international call, the present invention would assign the first domestic call to Carrier A, the next domestic call to Carrier B, and the third international call to Carrier A. By using best cost routing, the total cost to the telecommunications provider is $0.071 per minute.

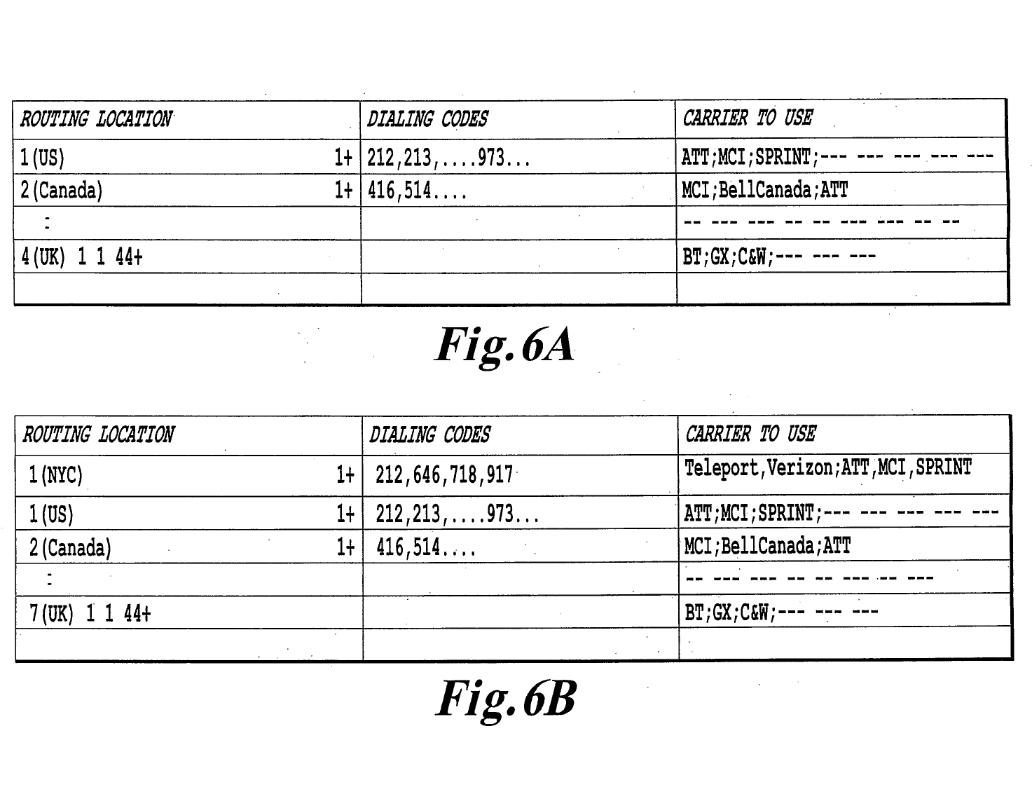

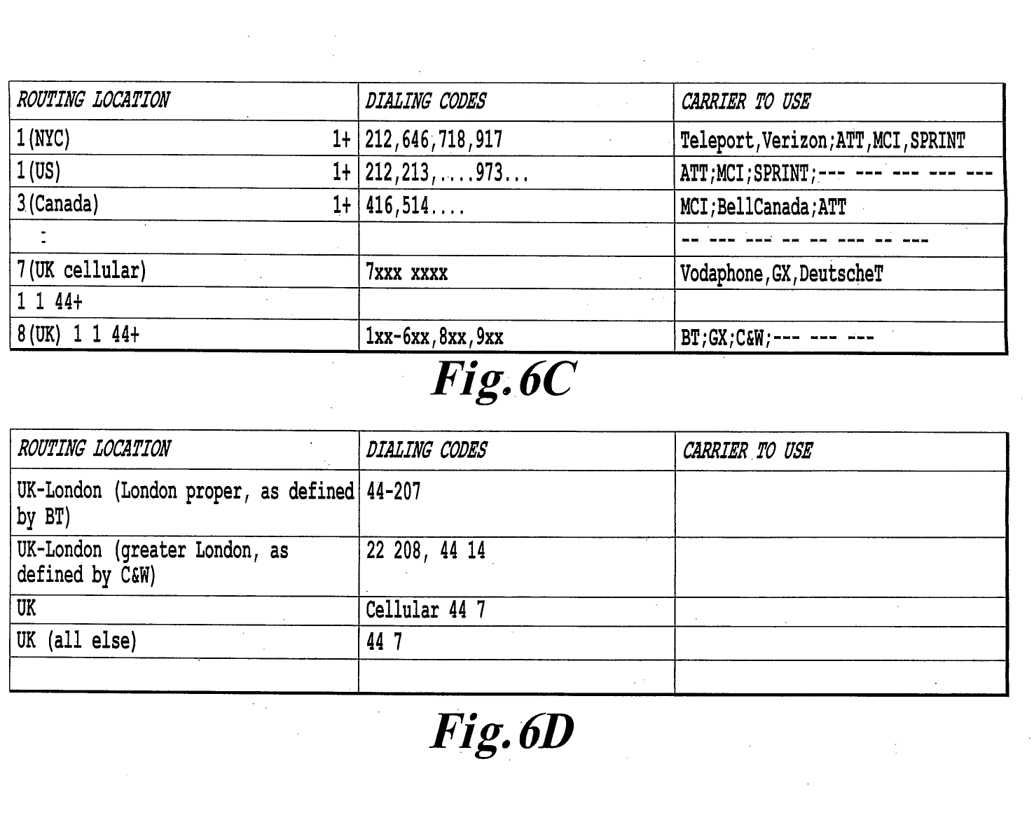

The best cost route is a function of the destination, the customer, the current network status, prioritized routes, the carrier, quality requirements, and applicable business rules, as well as other factors known to those of skill in the art. FIGS. 6A-6C illustrate non-limiting examples of routing tables that may be developed to execute the present invention. For example, a switch determines a routing location by mapping the digits of the desired phone number. In the example of FIG. 6B, certain carriers offer advantageous rates for calls being completed to New York City (NYC). Thus, for calls to NYC, these carriers are listed at the top of the routing table in a “break out.” Break outs may be created for any area that has a particularly advantageous rate.

The example of FIG. 6C illustrates international cell phone calls. For most non-North American countries, the calling party pays for cell phone charges. In FIG. 6C, the destinations for cell phone charges are broken out by best rates. In the example of FIG. 6C, the switch recognizes that UK cell calls are routed to a particular list of carriers. This list may be very different that a list of carriers to use for UK non-cell destinations (based on, for example, the ability to generate caller identification).

To overcome these heterogeneous destination routing difficulties, the present invention creates a homogeneous routing location. A homogeneous routing location is a destination defined by dial codes, for which every carrier to that destination offers a constant rat to every destination phone number within the location. The table in FIG. 6D illustrates how the present invention applies a homogeneous routing location system to the routing table of FIG. 6C. In this example, each homogeneous routing location becomes a breakout. Because the present invention is capable of maintaining the route list off the switches, the present invention is no longer constrained by the limits of switch memory (for example, a switch is generally limited to 1500 routing locations). Absent this constraint, the present invention is able to capitalize upon greater rate savings across the telecommunication provider's network.

Additionally, through the use of the routing lists, it is possible to track a call as it traverses the network. In other words, it is possible to track outbound trunk usage and capacity. It is also possible to track carrier quality and call completion rate, among other things.

The present invention also enables the telecommunications provider to query the routing lists to locate a current ordered list of outbound trunks for a particular customer. Because the call control layer generally operates in real time, the queries are performed using, for example, an in memory database. The routing list is preferably comprised of outbound trunks ordered by rate, quality, priority, and other factors impacted by routing rules. A weighted average of all of these factors may be used to determine a trunk's position in the routing lists.

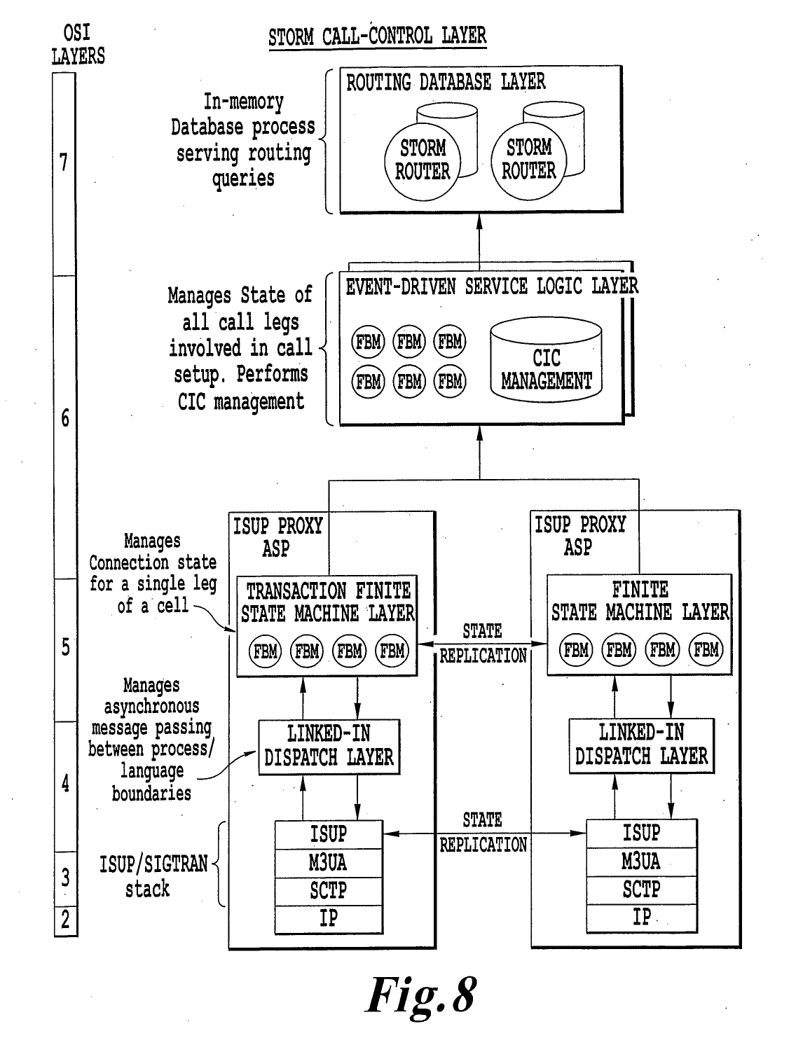

FIG. 8 provides a non-limiting example of the configuration of the call control layer according to an aspect of the present invention. As shown in FIG. 8, the routing database layer includes an in-memory database process serving routing queries. The event driven service logic layer manages the state of all call legs involved in call setup and performs CIC management. Circuit Identification Code (CIC) management is a standard ISUP procedure that defines the way logical circuit numbers (e.g., integers) get mapped into physical trunk and channel numbers carrying voice traffic.

The next level of the call control layer includes ISUP proxy ASP. The ISUP proxy ASPs include several layers. The transaction finite state machine layer manages a connection state for a single leg of a call. The linked-in dispatch layer manages asynchronous message passing between process and/or language boundaries. The ISUP/SIGTRAN stack in each ISUP proxy ASP communicates with the other stack in the other ISUP proxy ASP through state replication. Finally, the ISUP proxy ASP communicates with another distributed state machine layer that manages call state throughout the entire call setup (potentially across multiple switch signaling points). That layer implements the main routing logic that performs hierarchical lookups in a database containing routing instructions.

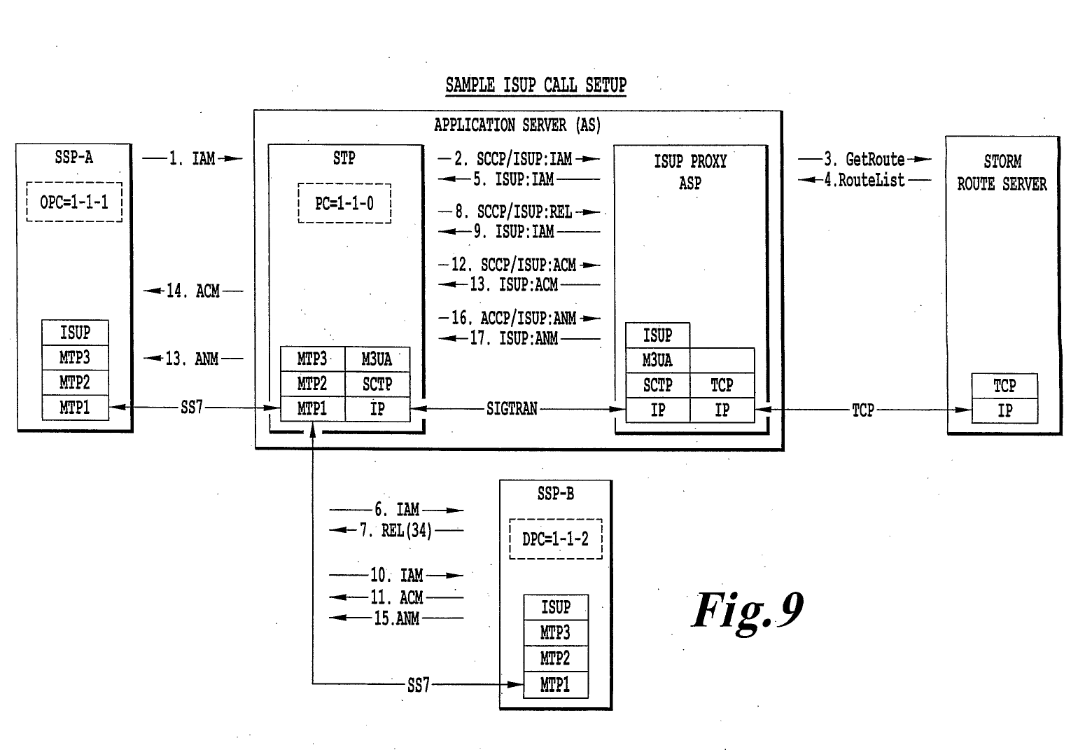

A sample ISUP call setup is provided in FIG. 9. As illustrated in FIG. 9, the SSP=A sends an IAM (OPC=1-1-1, DPC=1-1-2). Originating Point Code (OPC) and Destination Point Code (DPC) are standard addressing elements in the SS7 specification, and are similar to IP addresses in the TCP/IP network communications.

The STP does DTA redirect based on the OPC/DPC address through its M3UA interface to the ISUP proxy. The ISUP proxy then queries the STORM route server for a list of outbound trunk groups represented by CdPA prefixes. In response, the route server returns a list of outbound trunk groups.

The ISUP proxy selects the first prefix, adds it to the CdPA field, adds state information in the User-to-User information field, and returns a new IAM to the STP. The STP executes DPC routing of the IAM (OPC=1-1-1, DPC=1-1-2) message to the SSP-B. The SSP-B performs routing based on the prefix present in CdPA and determines that the requested trunk group is not available. It returns REL (cause code 34). By way of example, REL (cause code 34) may be an error code indicating a local congestion that is interpreted by the ISUP Proxy ASP as the instruction to advance to the next trunk in the routing list.

The STP then performs DTA redirect based on the OPC/DPC (OPC=1-1-2, DPC=1-1-1) address through its SIGTRAN/SS7 interface to the ISUP proxy. The ISUP proxy then fetches the call state from the User-to-User information field, selects the next prefix, adds the prefix to the CdPA field, and returns IAM to the STP. STP executes DPC routing of the IAM (OPC=1-1-1, DPC=1-1-2) message to the SSP-B.

SSP-B performs routing based on the prefix present in CdPA and successfully reserves and rings the line. It returns ACM to the STP. STP performs DTA redirect based on the prefix present in CdPA, and successfully reserves and rings the line. It returns ACM to the STP. STP then performs DTA redirect based on the OPC/DPC (OPC=1-1-2, DPC=1-1-1) address through its SIGTRAN/SS7 interface to the ISUP proxy. The ISUP proxy forward the ACM to the calling party SSP-A. The STP then performs DPC routing of the ACM (OPC=1-1-2, DPC=1-1-1) message to SSP-A. Subsequently, the SSP-B detects a called party answer and returns ANM to the STP. The STP performs DTA redirect based on the OPC/DPC (OPC=1-1-2, DPC=1-1-1) address through its SIGTRAN/SS7 interface to the ISUP proxy. The ISUP proxy forwards ACM to the calling party SSP-A. The STP does DPC routing of the ANM (OPC=1-1-2, DPC=1-1-1) message to the SSP-A.

While DTA has been used in the foregoing example, it is noted that DTA may be a vendor specific protocol. Accordingly, analogous protocols are within the scope of the present invention. Additionally, while the above example includes SIGTRAN for purposes of efficiency, standard SS7 interfaces are also suitable. IAM, ACM, ANM, REL, RLC are standard message types in the ISUP protocol.

Consequently, through the present invention, it is possible to generate routes for calls originating from different customers requiring different levels of quality. This route differentiation enables the improvement of profits for the telecommunications provider while satisfying a wider variety of service level agreements.

Other benefits of the present invention include the ability to avoid banding by customer or division, that fall tandem trunk capacity becomes available for revenue traffic, new generation switches may be deployed without recoding, the possibility of faster responses to network conditions (thereby generating higher customer satisfaction), actions may be automated, and switch ports may be freed for other traffic.

The present invention includes processing of transmitted and received signals, and programs by which the received signals are processed. Such programs are typically stored and executed by a processor. The processor typically includes a computer program product for holding instructions programmed and for containing data structures, tables, records, or other data. Examples are computer readable media such as compact discs, hard disks, floppy disks, tape, magneto-optical disks, PROMs (EPROM, EEPROM, flash EPROM), DRAM, SRAM, SDRAM, or any other magnetic medium, or any other medium from which a processor can read.

The computer program product of the invention may include one or a combination of computer readable media to store software employing computer code devices for controlling the processor. The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

Obviously, numerous modifications and variations of the present invention are possible in light of the above teachings. It is therefore to be understood that within the scope of the appended claims, the invention may be practiced otherwise than as specifically described herein.

1. A method of routing calls through a network, the method comprising:
receiving an incoming call at a signaling transfer point (STP);
transferring information related to the incoming call to a routing engine by decoding ISUP signaling information related to the incoming call;
determining an optimized route based at least in part on the transferred information; and
signaling the STP to route the call to a destination number using the optimized route.

2. The method according to claim 1, wherein the determining includes:
consulting information available in the routing engine; and
modifying an ISUP signaling packet to include additional information.

3. The method according to claim 1, wherein the transferred information includes at least one of an incoming trunk group, a customer characteristic, a destination telephone number, and a maximum number of routes requested.

4. The method according to claim 3, wherein the customer characteristic includes at least one of a service requirement, an acceptable margin of cost, and a usage commitment.

5. The method according to claim 4, wherein the service requirement includes a call quality requirement.

6. The method according to claim 1, wherein the optimized route includes a shortest path across a tandem switch to a desired outbound trunk, wherein the tandem switch interfaces between a voice over a combination of internet protocol network or TDM network.

7. The method according to claim 1, further comprising signaling to the routing engine that the optimized route failed.

8. The method according to claim 7, further comprising providing a second optimized route to the STP.

9. The method according to claim 8, further comprising completing the incoming call using the second optimized route.

10. The method according to claim 1, further comprising:
altering content of an ISUP message signaling unit (MSU) by setting additional ISUP parameters for custom routing while preserving an original MSU routing header.

11. The method according to claim 1, wherein a destination switch performs call completion or rejection on a trunk group identified by analyzing custom parameters present in an ISUP message signaling unit.

12. A system for routing calls through a network, the system comprising:
a signaling transfer point (STP) configured to receive an incoming call;
means for transferring information related to the incoming call to a routing engine, including means for decoding ISUP signaling information related to the incoming call;
means for determining an optimized route based at least in part on the transferred information; and
means for signaling the STP to route the call to a destination number using the optimized route.

13. The system according to claim 12, wherein the means for determining includes:
means for consulting information available in the routing engine; and
means for modifying an ISUP signaling packet to include additional information.

14. The system according to claim 12, wherein the transferred information includes at least one of an incoming trunk group, a customer characteristic, a destination telephone number, and a maximum number of routes requested.

15. The system according to claim 14, wherein the customer characteristic includes at least one of a service requirement, an acceptable margin of cost, and a usage commitment.

16. The system according to claim 15, wherein the service requirement includes a call quality requirement.

17. The system according to claim 12, wherein the optimized route includes a shortest path across a tandem switch to a desired outbound trunk, wherein the tandem switch interfaces between a voice over internet protocol network and another network.

18. The system according to claim 12, further comprising means for signaling to the routing engine that the optimized route failed.

19. The system according to claim 16, further comprising means for providing a second optimized route to the STP.

20. The system according to claim 19, further comprising means for completing the incoming call using the second optimized route.

21. The system according to claim 12, further comprising:
means for altering content of an ISUP message signaling unit (MSU) by setting additional ISUP parameters for custom routing while preserving an original MSU routing header.

22. The system according to claim 12, wherein a destination switch performs call completion or rejection on a trunk group identified by analyzing custom parameters present in an ISUP message signaling unit.

23. A computer program product storing a computer program, which when executed by a processor causes the processor to perform steps of:
receiving an incoming call at a signaling transfer point (STP);
transferring information related to the incoming call to a routing engine by decoding ISUP signaling information related to the incoming call;
determining an optimized route based at least in part on the transferred information; and
signaling the STP to route the call to a destination number using the optimized route.

24. The computer program product according to claim 23, wherein the processor further performs steps of:
consulting information available in the routing engine; and
modifying an ISUP signaling packet to include additional information.

25. The computer program product according to claim 23, wherein the transferred information includes at least one of an incoming trunk group, a customer characteristic, a destination telephone number, and a maximum number of routes requested.

26. The computer program product according to claim 25, wherein the customer characteristic includes at least one of a service requirement, an acceptable margin of cost, and a usage commitment.

27. The computer program product according to claim 26, wherein the service requirement includes a call quality requirement.

28. The computer program product according to claim 23, wherein the optimized route includes a shortest path across a tandem switch to a desired outbound trunk, wherein the tandem switch interfaces between a voice over internet protocol network and another network.

29. The computer program product according to claim 23, wherein the processor further performs a step of signaling to the routing engine that the optimized route failed.

30. The computer program product according to claim 29, wherein the processor further performs a step of providing a second optimized route to the STP.

31. The computer program product according to claim 30, wherein the processor further performs a step of completing the incoming call using the second optimized route.

32. The computer program product according to claim 23, wherein the processor further performs the step of:
altering content of an ISUP message signaling unit (MSU) by setting additional ISUP parameters for custom routing while preserving an original MSU routing header.

33. The computer program product according to claim 23, wherein the processor causes a destination switch to perform call completion or rejection on a trunk group identified by analyzing custom parameters present in an ISUP message signaling unit.
